(19) United States
(12) Patent Application Publication
(10) Pub. No.: US 2023/0384567 A1
(43) Pub. Date: Nov. 30, 2023

(54) OPTICAL UNIT

(71) Applicant: NIDEC INSTRUMENTS CORPORATION, Nagano (JP)

(72) Inventors: Tsutomu ARAI, Nagano (JP); Takeshi Sue, Nagano (JP)

(73) Assignee: NIDEC INSTRUMENTS CORPORATION, Nagano (JP)

(21) Appl. No.: 18/325,005

(22) Filed: May 29, 2023

(30) Foreign Application Priority Data
May 31, 2022 (JP) 2022-088296

(51) Int. Cl. G02B 13/00; G02B 7/18; H02K 41/035; G02B 26/08

(52) U.S. Cl. CPC G02B 13/0065; G02B 26/0816; H02K 41/0356; G02B 7/1805

(57) ABSTRACT

An optical unit includes a prism that is formed to have a triangular pole shape and a prism holder to which the prism is fixed by an adhesive. An incident surface on which the light from an outside enters, a reflection surface that reflects light that enters through the incident surface, and an emitting surface through which light reflected on the reflection surface is emitted are formed on the prism. A contact surface to which the reflection surface of the prism contacts, and an adhesive hole in which an adhesive that adheres to the reflection surface of the prism to fix the prism to the prism holder is disposed are formed in the prism holder. The adhesive hole passes through the prism holder.

### CROSS REFERENCE TO RELATED APPLICATION

The present invention claims priority under 35 U.S.C. § 119 to Japanese Application No. 2022-088296 filed May 31, 2022, the entire content of which is incorporated herein by reference.

### BACKGROUND

### Field of the Invention

At least an embodiment of the present invention relates to an optical unit including a prism and a prism holder to which the prism is fixed by an adhesive.

### Description of the Related Documents

Conventionally, an optical system including a lens unit, a reflection unit, and an image sensor is known (for example, see U.S. Patent Application Publication Number 2019/227300). In the optical system described in U.S. Patent Application Publication Number 2019/227300, the reflection unit includes a prism and a prism actuation mechanism. The prism actuation mechanism includes a moveable portion, a stable portion, and an actuation module. The moveable portion includes a prism holder to which the prism is fixed by an adhesive. The prism is formed to have a triangle shape. An incident surface on which light from an outside enters, a reflection surface that reflects light that enters through the incident surface, and an emitting surface through which light reflected on the reflection surface emits are formed on the prism.

In the optical system described in U.S. Patent Application Publication Number 2019/227300, a facing surface that faces the reflection surface of the prism is formed on the prism holder. Further, attachment wall portions that are disposed on the outsides of the both end surfaces of the triangle pole shaped prism are formed on the prism holder. A groove is formed on each of the attachment wall portions. In the optical system described in U.S. Patent Application Publication Number 2019/227300, when the prism is fixed to the prism holder, an adhesive is injected into the grooves of the attachment wall portions while the prism is disposed on a spacer that is disposed on the facing surface of the prism holder. The adhesive injected into the groove of the attachment wall portion spreads between the attachment wall portions and the end surfaces of the prism. The prism is fixed to the prism holder by the adhesive spread between the attachment wall portions and the end surfaces of the prism.

In the optical system described in U.S. Patent Application Publication Number 2019/227300, since the prism is fixed to the prism holder by the adhesive that spreads between the attachment wall portions of the prism holder and the end surfaces of the prism, when the prism is fixed to the prism holder by an adhesive, the adhesive may flow out from between the attachment wall portions and the end surfaces of the prism, and the adhesive that flows out may flow toward the incident surface and the emitting surface and adhere to the incident surface and the emitting surface. When the adhesive adheres to the incident surface and the emitting surface, light that is to go through the incident surface and the emitting surface is blocked by the adhesive and the function of the prism decreases. By strictly managing the amount of the adhesive injected into the groove on the attachment wall portions, the adhesive can be prevented from flowing over to prevent the adhesive from adhering to the incident surface and the emitting surface. In this case, the step of adhering the prism becomes complicated.

According to the above, at least an embodiment of the present invention provides an optical unit including a prism and a prism holder to which the prism is fixed by an adhesive in which it can be easily prevented that an adhesive adheres to an incident surface and an emitting surface.

### SUMMARY

An optical unit according to at least an embodiment of the present invention includes a prism that is formed to have a triangular pole shape and a prism holder to which the prism is fixed by an adhesive; an incident surface on which light from an outside enters, a reflection surface that reflects light that enters through the incident surface, and an emitting surface through which light reflected on the reflection surface is emitted are formed on the prism; a contact surface to which the reflection surface contacts, and an adhesive hole in which an adhesive that adheres to the reflection surface to fix the prism to the prism holder is disposed are formed in the prism holder; and the adhesive hole passes through the prism holder.

In the optical unit according to at least an embodiment of the present invention, the adhesive hole, in which the adhesive that adheres to the reflection surface of the prism to fix the prism to the prism holder is disposed, passes through the prism holder. Hence, in at least an embodiment of the present invention, by injecting the adhesive into the adhesive hole from an opening side of the adhesive hole so that the adhesive adheres to the reflection surface of the prism, it is possible that the prism is fixed to the prism holder by an adhesive. Therefore, in at least an embodiment of the present invention, when an amount of the adhesive injected into the adhesive hole is not strictly managed, it is possible to prevent the adhesive injected into the adhesive hole from flowing over the adhesive hole and flowing toward the incident surface and the emitting surface of the prism. As a result, in at least an embodiment of the present invention, it can be easily prevented that the adhesive adheres to the incident surface and the emitting surface of the prism.

In at least an embodiment of the present invention, the contact surface is formed to have an annular shape; and the adhesive hole is formed on an inner peripheral side of the contact surface. By configuring as described above, since the whole periphery of the adhesive hole is surrounded by the contact surface, it is possible to surely prevent the adhesive that enters the adhesive hole from flowing toward the incident surface and the emitting surface of the prism on the contact surface side. Further, by configuring as described above, since the contact surface to which the reflection surface of the prism contacts is formed to have an annular shape, the state of the prism that is fixed to the prism holder by an adhesive can be made stable.

In at least an embodiment of the present invention, the optical unit includes a holding body that rotatably holds the prism holder, and a magnetic actuation mechanism that rotates the prism holder with respect to the holding body; the magnetic actuation mechanism includes an actuation magnet that is fixed to one of the prism holder and the holding body, and an actuation coil that is fixed to the other of the prism holder and the holding body and is disposed to face the actuation magnet; and the adhesive hole passes through the prism holder in a direction that is inclined with respect to a facing direction in which the actuation magnet and the actuation coil face each other.

By configuring as described above, it is possible that, after the actuation magnet or the actuation coil is fixed to the prism holder, the adhesive is injected into the adhesive hole from the opening side of the adhesive hole to fix the prism to the prism holder by an adhesive. Therefore, when the actuation magnet or the actuation coil is fixed to the prism holder, a problem that dusts adhere to the prism fixed to the prism holder by an adhesive can be prevented.

In at least an embodiment of the present invention, the adhesive hole passes through the prism holder in a direction that is inclined with respect to the facing direction by 90 degrees. By configuring as described above, since the opening of the adhesive hole can be made larger, the work of injecting the adhesive into the adhesive hole can be easily conducted.

In at least an embodiment of the present invention, the prism holder has a rib that is disposed in the adhesive hole for reinforcement purpose; and an end surface of the rib on the contact surface side and the reflection surface are out of contact with each other and are separated from each other. By configuring as described above, an adhesive can be injected between the end surface of the rib on the contact surface side and the reflection surface of the prism. Therefore, a surface area of the prism that is adhered to the prism holder can be made larger by using the end surface of the rib on the contact surface side, and as a result, the adhesion strength of the prism with respect to the prism holder can be increased.

In at least an embodiment of the present invention, end surface of the rib on the contact surface side is chamfered. By configuring as described above, an adhesive easily enters between the end surface of the rib on the contact surface side and the reflection surface of the prism.

In at least an embodiment of the present invention, the prism holder includes a side wall portion on which a facing surface that faces an end surface of the prism formed to have a triangular pole shape is formed; a positioning protrusion that positions the prism, in a state in which the reflection surface is in contact with the contact surface, with respect to the prism holder is formed on the side wall portion; and the incident surface or the emitting surface contacts to the positioning protrusion to position the prism with respect to the prism holder. By configuring as described above, the state of the prism when the prism is fixed to the prism holder by an adhesive can be made stable.

As described above, in at least an embodiment of the present invention, in an optical unit including a prism and a prism holder to which the prism is fixed by an adhesive, it can be easily prevented that the adhesive adheres to the incident surface and the emitting surface of the prism.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a perspective view of an optical unit according to at least an embodiment of the present invention;

FIG. 2 is a perspective view of a smart phone in which the optical unit shown in FIG. 1 is incorporated;

FIG. 3 is a schematic view for explaining a configuration of a camera incorporated in the smart phone shown in FIG. 2;

FIG. 4 is an exploded perspective view of the optical unit shown in FIG. 1;

FIG. 5 is a sectional view of a prism and a prism holder shown in FIG. 1;

FIG. 6 is a perspective view in which the prism and the prism holder shown in FIG. 1 are shown in a different direction;

FIG. 7 is a perspective view of the prism holder shown in FIG. 4; and

FIG. 8 is a plan view of the prism holder shown in FIG. 7.

### DETAILED DESCRIPTION

Hereinafter, embodiments of the present invention are described with reference to the drawings.

Overall Configuration of Optical Unit

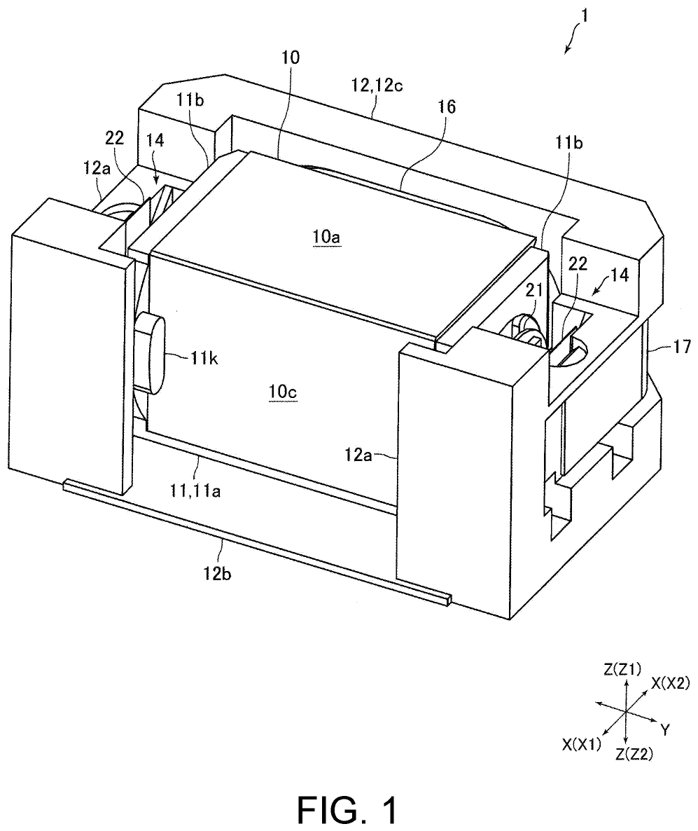

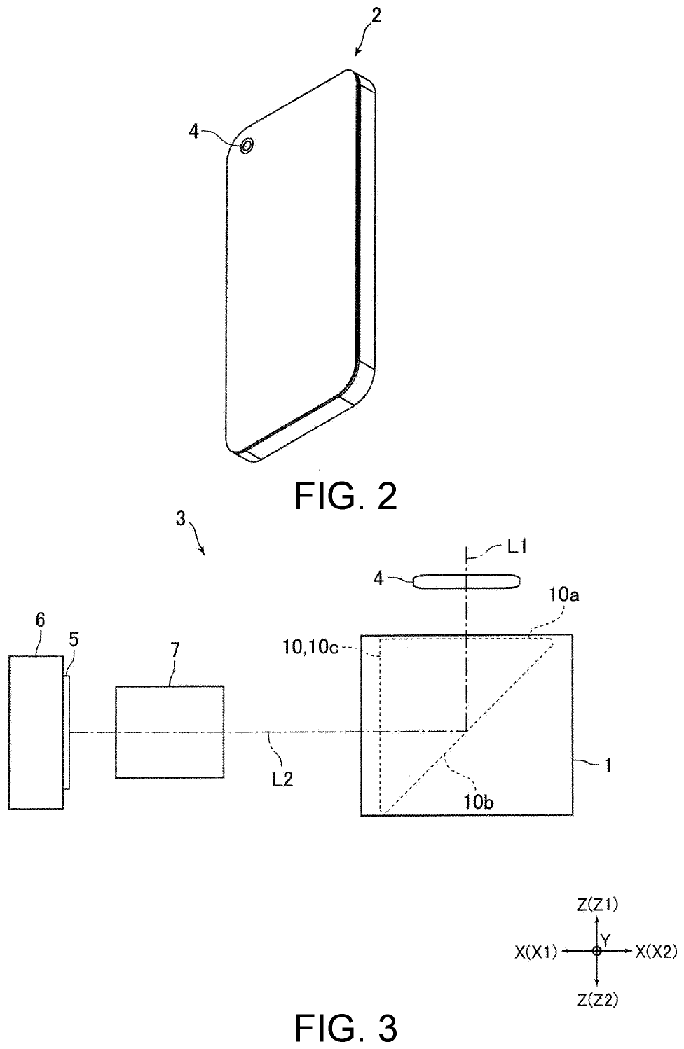

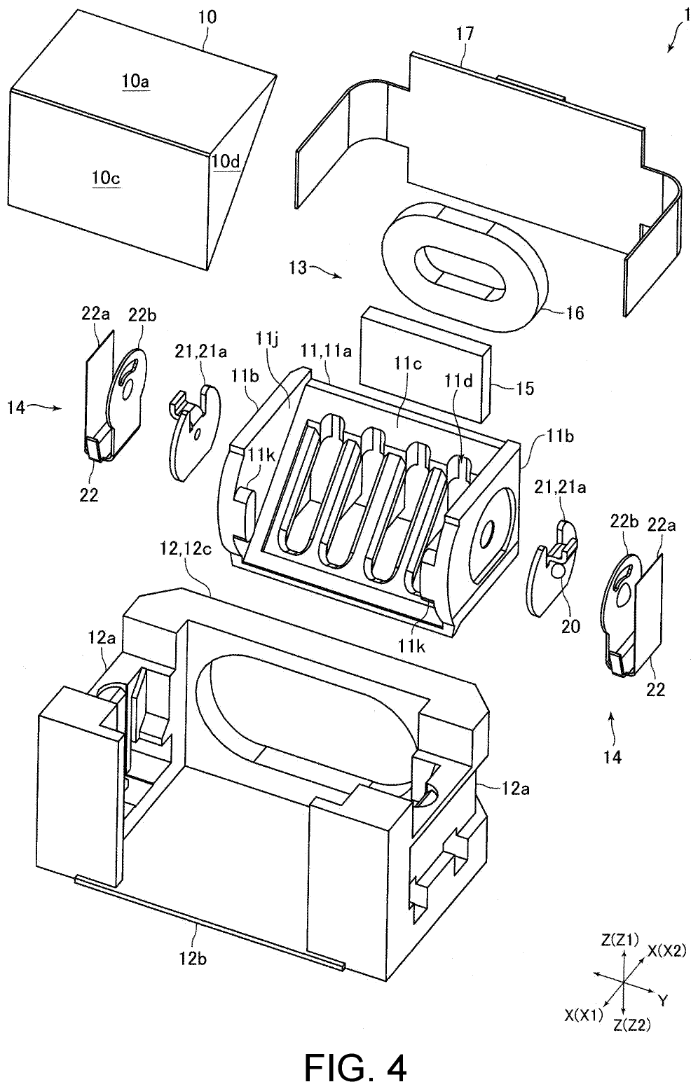

FIG. 1 is a perspective view of an optical unit 1 according to at least an embodiment of the present invention. FIG. 2 is a perspective view of a smart phone 2 in which the optical unit 1 shown in FIG. 1 is incorporated. FIG. 3 is a schematic view for explaining a configuration of a camera 3 incorporated in the smart phone 2 shown in FIG. 2. FIG. 4 is an exploded perspective view of the optical unit 1 shown in FIG. 1.

The optical unit 1 of this embodiment has a deflection correction function for correcting a deflection of an optical image. The optical unit 1 is, for example, incorporated in the smart phone 2. Further, the optical unit 1 configures a part of the camera 3 incorporated in the smart phone 2. The camera 3 includes a lens 4 into which light from an outside of the smart phone 2 enters, and a substrate 6 on which an imaging element 5 is mounted. Note that the optical unit 1 may be incorporated in a mobile device, etc. other than the smart phone 2.

In the camera 3, an optical axis L1 of the lens 4 and a normal line L2 passing through the center of an imaging surface of the imaging element 5 are orthogonal to each other. That is, the optical axis L1 of the lens 4 and the imaging surface of the imaging element 5 are parallel to each other. The optical unit 1 is disposed between the lens 4 and the imaging element 5 on an optical path from the lens 4 to the imaging element 5. A lens 7 is disposed between the optical unit 1 and the imaging element 5. An optical axis of the lens 7 corresponds to the normal line L2.

The optical unit 1 includes a prism 10 that is formed to have a triangular pole shape. An incident surface 10a on which light from an outside enters, a reflection surface 10b that reflects light that enters through the incident surface 10a, and an emitting surface 10c through which light reflected on the reflection surface 10b is emitted are formed on the prism 10. An angle between the incident surface 10a and the emitting surface 10c is 90 degrees and a cross sectional shape of the prism 10 is a right-angled triangle shape. More specifically, the cross-sectional shape of the prism 10 is a right-angled isosceles triangle shape. Light from an outside of the smart phone 2 enters the incident surface 10a via the lens 4. The reflection surface 10b deflects the optical axis of the incident light on the reflection surface 10b by substantially 90 degrees. The emitting surface emits the light reflected on the reflection surface 10b to the imaging element 5.

In an explanation below, a direction of the optical axis L1 of the lens 4 (Z-direction in FIG. 1, etc.) is defined as an up-down direction, a direction of the normal line L2 on the imaging surface of the imaging element 5 (X-direction in FIG. 1, etc.) is defined as a front-rear direction, and a direction such as a Y-direction in FIG. 1, etc. orthogonal to the up-down direction and the front-rear direction is defined as a left-right direction. Further, in the up-down direction, a side of the optical unit 1 on which the lens 4 is disposed (Z1-direction side in FIG. 1, etc.) is defined as “up” side, and a Z2-direction side in FIG. 1, etc. that is opposite to the up side is defined as “down” side. Further, in the front-rear direction, a side of the optical unit 1 on which the imaging element is disposed (X1-direction side in FIG. 1, etc.) is defined as “front” side, and a X2-direction side in FIG. 1, etc. that is opposite to the front side is defined as “rear” side.

The optical unit 1 includes, in addition to the prism 10, a prism holder 11 to which the prism 10 is fixed by an adhesive, a holding body 12 that rotatably holds the prism holder 11, and a magnetic actuation mechanism 13 that rotates the prism holder 11 with respect to the holding body 12. Further, the optical unit 1 includes a rotation axis portion 14 that configures a rotation center of the prism holder 11 with respect to the holding body 12. The prism holder 11 can rotate with respect to the holding body 12 about the left-right direction as an axis of rotation.

When the prism holder 11 is disposed at a predetermined base position, the incident surface 10a of the prism 10 is orthogonal to the up-down direction and the emitting surface 10c is orthogonal to the front-rear direction. Further, the end surfaces 10d (see FIG. 4) of the prism 10 formed to have a triangular pole shape are flat surfaces orthogonal to the left-right direction. The optical unit 1 corrects the deflection of the optical image by the rotation action of the prism holder 11 with respect to the holding body 12. Note that, since the angle of rotation of the prism holder 11 with respect to the holding body 12 is not so large when the correction of the deflection is conducted, the incident surface 10a is substantially orthogonal to the up-down direction and the emitting surface 10c is substantially orthogonal to the front-rear direction during the correction of the deflection.

The prism holder 11 is formed of a resign material. The prism holder 11 includes a holder main body portion 11a formed to have a triangular pole shape and two side wall portions 11b connected to both ends of the holder main body portion 11a. The prism holder 11 of this embodiment is configured by the holder main body portion 11a and the two side wall portions 11b. The holder main body portion 11a is disposed so that an axial direction of the holder main body portion 11a formed to have a triangular pole shape and the left-right direction correspond to each other. The side wall portions 11b are connected to both ends of the holder main body portion 11a in the left-right direction. Each of the side wall portions 11b is formed to have a rectangular flat plate shape. The side wall portion 11b is disposed so that the thickness direction of the side wall portion 11b and the left-right direction correspond to each other. The specific configuration of the prism holder 11 is described below.

The holding body 12 is formed of a resign material. The holding body 12 is configured by two side surface portions 12a that configure the side surfaces of the holding body 12 in the left-right direction, a bottom surface portion 12b that configures a bottom surface of the holding body 12, and a rear surface portion 12c that configures a rear surface of the holding body 12. The prism holder 11 is disposed between the two side surface portions 12a in the left-right direction. Further, the prism holder 11 is disposed above the bottom surface portion 12b and in front of the rear surface portion 12c.

The magnetic actuation mechanism 13 includes an actuation magnet 15 that is fixed to the prism holder 11 and an actuation coil 16 that is disposed to face the actuation magnet 15. The actuation magnet 15 is fixed to the rear surface of the holder main body portion 11a. The actuation coil 16 is disposed behind the actuation magnet 15 and faces the actuation magnet 15 in the front-rear direction. The front-rear direction (X-direction) in this embodiment is a facing direction in which the actuation magnet 15 and the actuation coil 16 face each other. The actuation coil 16 is mounted on a flexible print circuit (FPC) 17. The FPC 17 is fixed to the holding body 12. That is, the actuation coil 16 is fixed to the holding body 12 via the FPC 17. A through hole in which the actuation coil 16 is disposed is formed on the rear surface portion 12c of the holding body 12.

The rotation axis portion 14 includes sphere-shaped two balls 20 that are each disposed on an outside of the prism holder 11 in the left-right direction, two ball fixing plates 21 to which the two balls 20 are fixed, and two plate springs 22 that push the balls 20 toward the inside in the left-right direction. The balls 20, the ball fixing plates 21, and the plate springs 22 are formed of metallic material such as steel. Each of the ball fixing plates 21 includes a ball fixing portion 21a formed to have a flat plate shape. The ball fixing portion 21a is disposed so that the thickness direction of the ball fixing portion 21a and the left-right direction correspond to each other.

The ball fixing plate 21 is fixed to the prism holder 11 with the ball fixing plate 21 being disposed in a recess formed on the outside surface in the left-right direction of the side wall portion 11b of the prism holder 11. Further, the ball fixing plate 21 is fixed to the prism holder 11 by an adhesive. A through hole for stabilizing the fixed state of the ball 20 is formed at the center of the ball fixing portion 21a. A part of the ball 20 is disposed in the through hole of the ball fixing portion 21a. The ball 20 is fixed to the outside surface of the ball fixing portion 21a in the left-right direction by welding.

Each of the plate spring 22 includes a fixed portion 22a that is fixed to the holding body 12, and a spring portion 22b that is connected to the fixed portion 22a. The fixed portion 22a is mounted to an inside surface in the left-right direction of the side surface portion 12a of the holding body 12. The spring portion 22b is disposed on an inside of the fixed portion 22a in the left-right direction. A receiving surface having a concave curved surface shape to which the ball 20 contacts is formed on the spring portion 22b. This receiving surface is recessed toward the outside in the left-right direction. The two balls 20 are disposed at the same position in the up-down direction. The prism holder 11 rotates with respect to the holding body 12 around an axis line that passes through the center of the two balls 20 as a center of rotation.

Configuration of Prism Holder

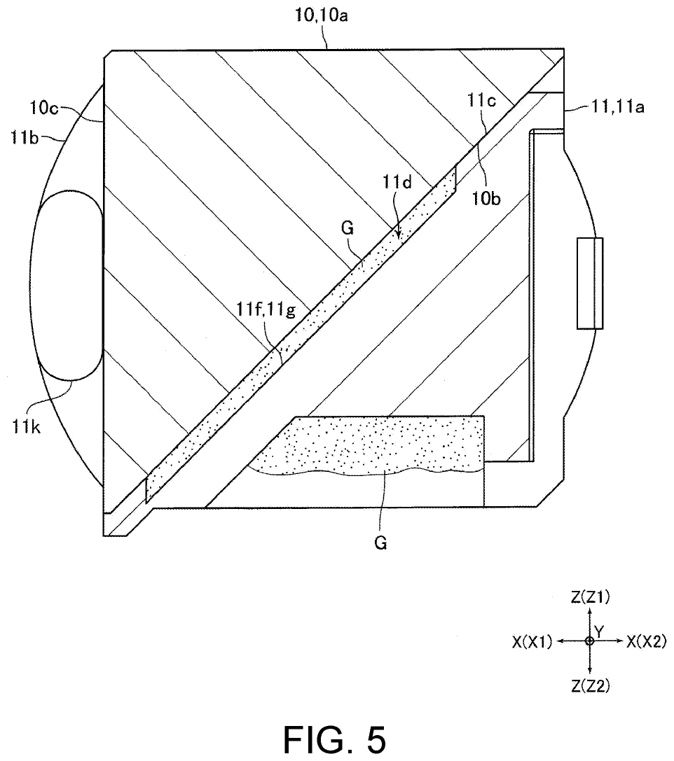

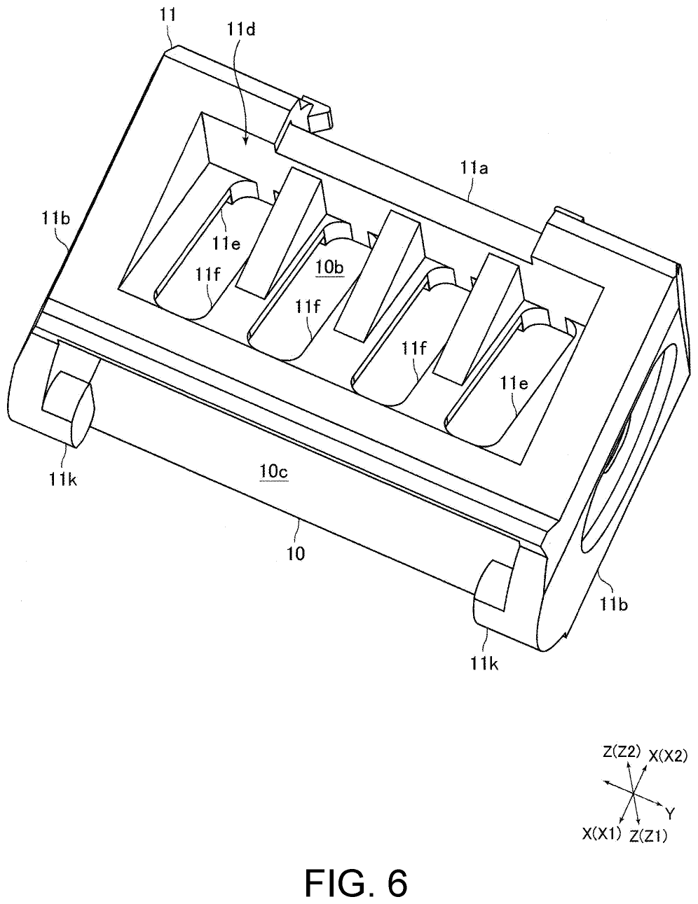

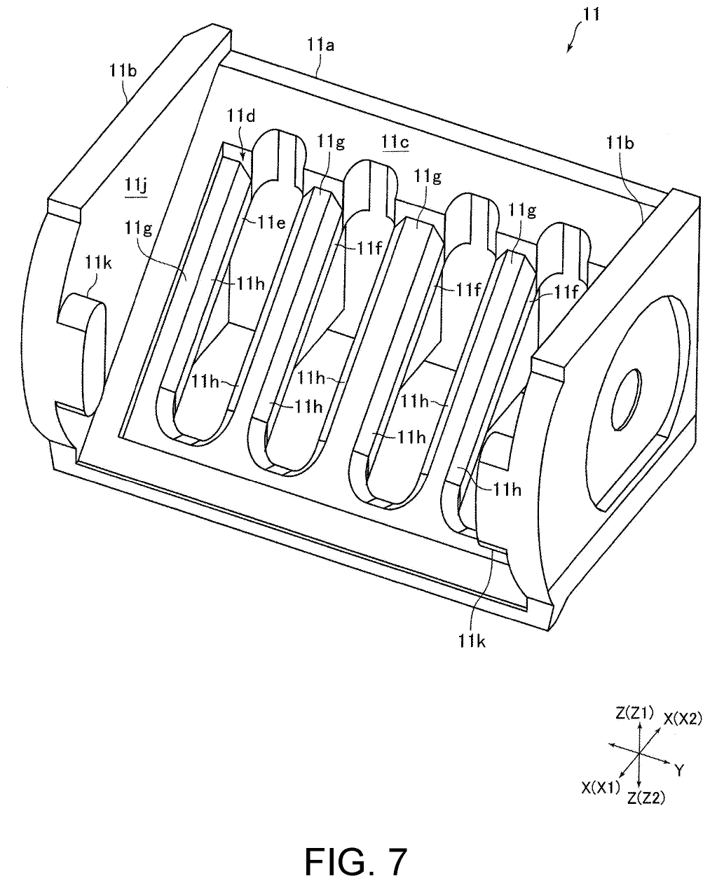

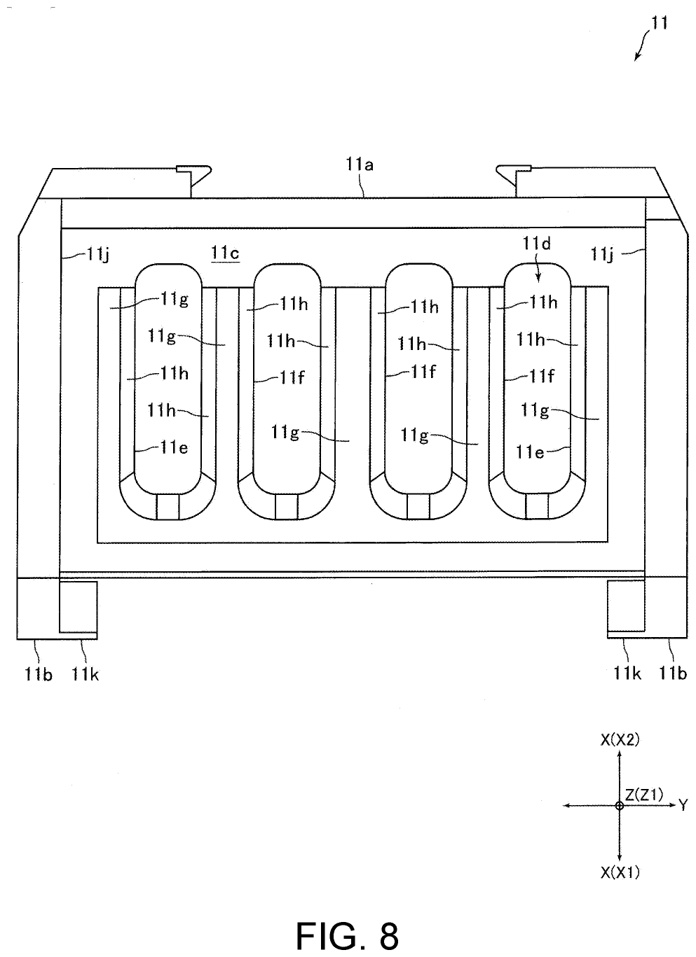

FIG. 5 is a sectional view of the prism 10 and the prism holder 11 shown in FIG. 1. FIG. 6 is a perspective view in which the prism 10 and the prism holder 11 shown in FIG. 1 are shown in a different direction. FIG. 7 is a perspective view of the prism holder 11 shown in FIG. 4. FIG. 8 is a plan view of the prism holder 11 shown in FIG. 7.

As described above, the prism holder 11 is configured by the holder main body portion 11a formed to have a triangular pole shape, and the two side wall portions 11b that are connected to both ends in the left-right direction of the holder main body portion 11a. The holder main body portion 11a is disposed so that the rear surface of the holder main body portion 11a is substantially orthogonal to the front-rear direction and the lower surface of the holder main body portion 11a is substantially orthogonal to the up-down direction. The prism 10 is disposed on the front upper side of the holder main body portion 11a. Further, the prism 10 is disposed between the two side wall portions 11b in the left-right direction. A contact surface 11c to which the reflection surface 10b of the prism 10 contacts, an adhesive hole 11d in which an adhesive G for fixing the prism 10 to the prism holder 11 by an adhesive is disposed, and ribs 11e, 11f for reinforcement that are disposed in the adhesive hole 11d are formed in the holder main body portion 11a.

A front upper surface of the holder main body portion 11a is the contact surface 11c. The contact surface 11c is a flat inclined surface that is inclined so as to become lowered as approaching to the front side. The contact surface 11c is formed to have an annular shape. Further, the contact surface 11c is formed to have a rectangular frame shape. Specifically, the contact surface 11c is formed to have a rectangular frame shape in which the direction of the long sides of the rectangular frame shape corresponds to the left-right direction. The reflection surface 10b of the prism 10 contacts to the contact surface 11c from the front upper side.

The adhesive hole 11d is formed on the inner peripheral side of the contact surface 11c. That is, the inner peripheral side of the contact surface 11c corresponds to the adhesive hole 11d. The adhesive hole 11d passes through the prism holder 11. In this embodiment, the adhesive hole 11d passes through the prism holder 11 in a direction that is inclined with respect to the front-rear direction in which the actuation magnet 15 and the actuation coil 16 face each other. Specifically, the adhesive hole 11d passes through the prism holder 11 in the up-down direction that is inclined with respect to the front-rear direction by 90 degrees. More specifically, when the prism holder 11 is disposed at the predetermined base position, the adhesive hole 11d passes through the prism holder 11 in the up-down direction. The adhesive hole 11d passes through the holder main body portion 11a from the lower surface of the holder main body portion 11a to the front upper surface of the holder main body portion 11a.

As described above, the ribs 11e, 11f are formed in the adhesive hole 11d. In this embodiment, a plurality of ribs 11e, 11f are formed in the adhesive hole 11d. Specifically, the rib 11e is formed on each of both ends of the adhesive hole 11d in the left-right direction and three ribs 11f are formed between the two ribs 11e. The three ribs 11f are, for example, disposed at a predetermined pitch in the left-right direction. The front lower ends of the two ribs 11e and the front lower ends of the three ribs 11f are connected to each other.

A part of the adhesive hole 11d is covered by the ribs 11e, 11f. In this embodiment, parts of the adhesive hole 11d between the ribs 11e, 11f pass through the prism holder 11 in the up-down direction. That is, in this embodiment, four rectangular shaped holes pass through the prism holder 11 in the up-down direction. The shape of each of the four holes when seen in the up-down direction is a rectangular shape in which long sides of the rectangular shape correspond to the front-rear direction.

The end surfaces of the ribs 11e, 11f on the contact surface 11c side (that is, front upper end surfaces of the ribs 11e, 11f, hereinafter each referred to as “end surface 11g”) are each formed to have a flat surface. The end surfaces 11g are disposed below the contact surface 11c. Therefore, the end surfaces 11g and the reflection surface 10b are out of contact with each other and are separated from each other. In this embodiment, the contact surfaces 11c and the end surface 11g are parallel to each other and a predetermined gap is formed between each of the end surfaces 11g and the reflection surface 10b. Each of the end surface 11g is chamfered. That is, chamfered portions 11h formed by chamfering are formed on the edges of the end surface 11g.

The inner side surface of the side wall portion 11b in the left-right direction is the facing surface 11j that faces the end surface 10d of the prism 10. That is, the facing surface 11j is formed on the side wall portion 11b. The facing surface 11j faces the end surface 10d via a small gap. A positioning protrusion 11k is formed on the side wall portion 11b. The positioning protrusion 11k positions the prism 10 in a state in which the reflection surface 10b of the prism 10 is in contact with the contact surface 11c with respect to the prism holder 11. The positioning protrusion 11k is formed on the front end side of the side wall portion 11b. The positioning protrusion 11k protrudes toward the inner side in the left-right direction.

The rear surface of the positioning protrusion 11k is a flat surface that is orthogonal to the front-rear direction. In this embodiment, the emitting surface 10c of the prism 10 contacts to the positioning protrusion 11k, and thereby, the prism 10 is positioned with respect to the prism holder 11. Specifically, the end portion of the emitting surface 10c in the left-right direction contacts to the rear surface of the positioning protrusion 11k, and thereby, the prism 10 in a state in which the reflection surface 10b is in contact with the contact surface 11c is positioned with respect to the prism holder 11.

When the prism 10 is fixed to the prism holder 11 by an adhesive, the reflection surface of the prism 10 is brought into contact with the contact surface 11c and the emitting surface is brought into contact with the rear surface of the positioning protrusion 11k. After that, while this state is being kept, the prism 10 and the prism holder 11 are turned upside down. In this state, a predetermined gap is formed between the end surfaces 11g of the ribs 11e, 11f and the reflection surface 10b. Further, in this state, one end of the adhesive hole 11d is covered by the prism 10.

In this state, the adhesive G is injected into the adhesive hole 11d through an opening on the other end of the adhesive hole 11d. The adhesive G injected into the adhesive hole 11d adheres to the reflection surface 10b. Further, the adhesive G enters between the end surfaces 11g and the reflection surface 10b. Note that, in this embodiment, before the prism 10 is fixed to the prism holder 11, the actuation magnet 15 is fixed to the prism holder 11. Further, illustration of the adhesive G is omitted in the FIG. 6.

### Main Effect of this Embodiment

As described above, in this embodiment, the adhesive hole 11d, in which the adhesive G that adheres to the reflection surface 10b of the prism 10 to fix the prism 10 to the prism holder 11 by an adhesive is disposed, passes through the prism holder 11. Hence, in this embodiment, as described above, by injecting the adhesive G into the adhesive hole 11d from the opening side of the adhesive hole 11d so that the adhesive G adheres to the reflection surface 10b, the prism 10 can be fixed to the prism holder 11 by an adhesive. Therefore, in this embodiment, when an amount of the adhesive G injected into the adhesive hole 11d is not strictly managed, it is possible to prevent the adhesive G injected into the adhesive hole 11d from flowing over the adhesive hole 11d and flowing toward the incident surface 10a and the emitting surface 10c of the prism 10. As a result, in this embodiment, it can be easily prevented that the adhesive G adheres to the incident surface 10a and the emitting surface 10c of the prism 10.

Further, in this embodiment, the contact surface 11c of the prism holder 11 to which the reflection surface 10b of the prism 10 contacts is formed to have an annular shape, and the adhesive hole 11d is formed on an inner peripheral side of the annular shaped contact surface 11c. That is, in this embodiment, the whole periphery of the adhesive hole 11d is surrounded by the contact surface 11c. Therefore, in this embodiment, it can be surely prevented that the adhesive G that enters the adhesive hole 11d flows toward the incident surface 10a and the emitting surface 10c of the prism 10 on the contact surface 11c side. Further, in this embodiment, since the contact surface 11c is formed to have an annular shape, the state of the prism 10 that is fixed to the prism holder 11 by an adhesive can be made stable.

In this embodiment, the adhesive hole 11d passes through the prism holder 11 in the up-down direction that is inclined by 90 degrees with respect to the front-rear direction in which the actuation magnet 15 and the actuation coil 16 face each other. Hence, in this embodiment, as described above, after the actuation magnet 15 is fixed to the prism holder 11, the adhesive G can be injected into the adhesive hole 11d to fix the prism 10 to the prism holder 11. Therefore, in this embodiment, when the actuation magnet 15 is fixed to the prism holder 11, a problem that dusts adhere to the prism 10 fixed to the prism holder 11 can be prevented.

Further, in this embodiment, since the adhesive hole 11d passes through the prism holder 11 in a direction that is inclined with respect to the front-rear direction by 90 degrees, the opening on the lower side of the adhesive hole 11d can be made larger. Therefore, in this embodiment, the work of injecting the adhesive G into the adhesive hole 11d can be easily conducted.

In this embodiment, the end surfaces 11g of the ribs 11e, 11f that are disposed in the adhesive hole 11d and the reflection surface 10b of the prism 10 that contacts to the contact surface 11c are out of contact with each other and are separated from each other. Hence, in this embodiment, as described above, the adhesive G also enters between the end surfaces 11g of the ribs 11e, 11f and the reflection surface 10b. Therefore, in this embodiment, a surface area of the prism 10 that is adhered to the prism holder 11 can be made larger by using the end surfaces 11g of the ribs 11e, 11f, and as a result, the adhesion strength of the prism 10 with respect to the prism holder 11 can be increased. Further, in this embodiment, since the end surfaces 11g of the ribs 11e, 11f are chamfered, the adhesive G easily enters between the end surfaces 11g of the ribs 11e, 11f and the reflection surface 10b of the prism 10.

In this embodiment, the positioning protrusion 11k is formed on the side wall portion 11b of the prism holder 11. The emitting surface 10c of the prism 10 contacts to the positioning protrusion 11k, and thereby, the prism 10 in a state in which the reflection surface 10b is in contact with the contact surface 11c is positioned with respect to the prism holder 11. Hence, in this embodiment, the state of the prism 10 when the prism 10 is fixed to the prism holder 11 by an adhesive can be made stable.

### Another Embodiment

Although the above-described embodiment is one of the exemplary embodiments of the present invention, the present invention is not limited thereto and can be modified in various ways in a range without altering the gist of the present invention.

In the embodiment described above, the positioning protrusion 11k may be formed so that the incident surface 10a of the prism 10 contacts to the positioning protrusion 11k, and thereby, the prism 10 is positioned with respect to the prism holder 11. In this case, the positioning protrusion 11k is formed on the upper end side of the side wall portion 11b and the lower surface of the positioning protrusion 11k is a flat surface orthogonal to the up-down direction. Further, the ends of the incident surface 10a in the left-right direction contact to the lower surfaces of the positioning protrusions 11k.

In the embodiment described above, the adhesive hole 11d may passes through the prism holder 11 in the front-rear direction. Specifically, when the prism holder 11 is disposed at the predetermined base position, the adhesive hole 11d may pass through the prism holder 11 in the front-rear direction. Further, in the embodiment described above, the end surfaces 11g of the ribs 11e, 11f may not be chamfered. Further, in the embodiment described above, the end surfaces 11g of the ribs 11e, 11f may be disposed on the same plane as the contact surface 11c, and the end surfaces 11g and the reflection surface 10b of the prism 10 may contact to each other. Further, in the embodiment described above, the ribs 11e, 11f may not be formed on the prism holder 11. Further, in the embodiment described above, the contact surface 11c may not be formed to have an annular shape.

In the embodiment described above, the actuation magnet 15 may be fixed to the holding body 12 and the actuation coil 16 may be fixed to the prism holder 11. Further, in the embodiment described above, the optical unit 1 may include a stable body that rotatably holds the holding body 12. In this case, the holding body 12 is rotatable with respect to the stable body about the up-down direction as the axial direction of the rotation. The optical unit 1 includes a magnetic actuation mechanism that rotates the holding body 12 with respect to the stable body and a rotation axis portion that configures the rotation center of the holding body 12 with respect to the stable body.

Configuration of the Present Technique

Note that the present technique may have configurations described below.
(1) An optical unit characterized in that: the optical unit includes a prism that is formed to have a triangular pole shape and a prism holder to which the prism is fixed by an adhesive; an incident surface on which light from an outside enters, a reflection surface that reflects light that enters through the incident surface, and an emitting surface through which light reflected on the reflection surface is emitted are formed on the prism;
a contact surface to which the reflection surface contacts, and an adhesive hole in which an adhesive that adheres to the reflection surface to fix the prism to the prism holder is disposed are formed in the prism holder; and the adhesive hole passes through the prism holder.
(2) The optical unit according to (1) characterized in that: the contact surface is formed to have an annular shape; and the adhesive hole is formed on an inner peripheral side of the contact surface.
(3) The optical unit according to (1) or (2) characterized in that: the optical unit includes a holding body that rotatably holds the prism holder, and a magnetic actuation mechanism that rotates the prism holder with respect to the holding body; the magnetic actuation mechanism includes an actuation magnet that is fixed to one of the prism holder and the holding body, and an actuation coil that is fixed to another of the prism holder and the holding body and is disposed to face the actuation magnet; the adhesive hole passes through the prism holder in a direction that is inclined with respect to a facing direction in which the actuation magnet and the actuation coil face each other.
(4) The optical unit according to (3) characterized in that the adhesive hole passes through the prism holder in a direction that is inclined with respect to the facing direction by 90 degrees.
(5) The optical unit according to any one of (1) to (4) characterized in that: the prism holder has a rib that is disposed in the adhesive hole for reinforcement purpose; and an end surface of the rib on the contact surface side and the reflection surface are out of contact with each other and are separated from each other.
(6) The optical unit according to (5) characterized in that an end surface of the rib on the contact surface side is chamfered.
(7) The optical unit according to any one of (1) to (6) characterized in that: the prism holder includes a side wall portion on which a facing surface that faces an end surface of the prism formed to have a triangular pole shape is formed; a positioning protrusion that positions the prism, in a state in which the reflection surface is in contact with the contact surface, with respect to the prism holder is formed on the side wall portion; and the incident surface or the emitting surface contacts to the positioning protrusion to position the prism with respect to the prism holder.

What is claimed is:

1. An optical unit comprising:
a prism that is formed to have a triangular pole shape; and
a prism holder to which the prism is fixed by an adhesive, wherein
an incident surface on which light from an outside enters, a reflection surface that reflects light that enters through the incident surface, and an emitting surface through which light reflected on the reflection surface is emitted are formed on the prism;
a contact surface to which the reflection surface contacts, and an adhesive hole in which an adhesive that adheres to the reflection surface to fix the prism to the prism holder is disposed are formed in the prism holder; and
the adhesive hole passes through the prism holder.

2. The optical unit according to claim 1, wherein
the contact surface is formed to have an annular shape; and
the adhesive hole is formed on an inner peripheral side of the contact surface.

3. The optical unit according to claim 1, comprising:
a holding body that rotatably holds the prism holder; and
a magnetic actuation mechanism that rotates the prism holder with respect to the holding body, wherein
the magnetic actuation mechanism comprises an actuation magnet that is fixed to one of the prism holder and the holding body, and an actuation coil that is fixed to the other of the prism holder and the holding body and is disposed to face the actuation magnet; and
the adhesive hole passes through the prism holder in a direction that is inclined with respect to a facing direction in which the actuation magnet and the actuation coil face each other.

4. The optical unit according to claim 3, wherein
the adhesive hole passes through the prism holder in a direction that is inclined with respect to the facing direction by 90 degrees.

5. The optical unit according to claim 1, wherein
the prism holder has a rib that is disposed in the adhesive hole for reinforcement purpose; and
an end surface of the rib on the contact surface side and the reflection surface are out of contact with each other and are separated from each other.

6. The optical unit according to claim 5, wherein
an end surface of the rib on the contact surface side is chamfered.

7. The optical unit according to claim 1, wherein
the prism holder comprises a side wall portion on which a facing surface that faces an end surface of the prism formed to have a triangular pole shape is formed;
a positioning protrusion that positions the prism, in a state in which the reflection surface is in contact with the contact surface, with respect to the prism holder is formed on the side wall portion; and
the incident surface or the emitting surface contacts to the positioning protrusion to position the prism with respect to the prism holder.
